(19) United States
(12) Patent Application Publication
(10) Pub. No.: US 2021/0042765 A1
(43) Pub. Date: Feb. 11, 2021

(54) PAYMENT INTERFACE DEVICE AND SYSTEM, PAYMENT METHOD, AND PAYMENT SERVER

(71) Applicant: Gil Hoon Chang, Seoul (KR)

(72) Inventor: Gil Hoon Chang, Seoul (KR)

(21) Appl. No.: 17/078,494

(22) Filed: Oct. 23, 2020

Related U.S. Application Data
(63) Continuation of application No. PCT/KR2019/004928, filed on Apr. 23, 2019.

(30) Foreign Application Priority Data
Apr. 25, 2018 (KR) 10-2018-0048117

(51) Int. Cl. G06Q 30/00; G06Q 20/02; G06Q 20/38; G06Q 20/40; G06Q 20/32; H04L 29/06; G10K 15/04

(52) U.S. Cl. CPC G06Q 30/0185; G06Q 20/02; G06Q 20/3829; G06Q 20/204; G06Q 20/3272; H04L 63/068; G10K 15/04; G06Q 20/4014

(57) ABSTRACT

A payment interface device and system, a payment method, and a payment server is provided. The system and method includes: a seller interface unit which acquires a payer identifier, which is identification information of a payer who has purchased a product, from a payment terminal carried by the payer, receives an input of payment information of the payer matching the acquired payer identifier, and requests a payment server for the payment from the payer, on the basis of the input payment information; and a payer interface unit which can be separated from the seller interface unit, and provides the payer with the payment information input to the seller interface unit.

### CROSS-REFERENCES TO RELATED APPLICATIONS

This application is a continuation application to PCT/KR2019/004928, having a filing date of Apr. 23, 2019, which is based upon and claims priority to Korean Patent Application No. 10-2018-0048117, having a filing date of Apr. 25, 2018, the entire contents of which are incorporated herein by reference.

### FIELD OF TECHNOLOGY

The following relates to a payment interface device and system, a payment method, and a payment server, and more specifically, to a payment interface device and system, a payment method, and a payment server that are capable of providing convenience of payment by dividing a payment device provided at a seller store into interfaces for a seller store cashier and a purchase payer.

### BACKGROUND

In general, a payment system through a credit card includes a seller store terminal (i.e. a point of sale (POS) terminal), a value added network (VAN) relay server, and a credit card payment server, and when a credit card is recognized by the seller store terminal, credit card information is transmitted via the VAN relay server to the credit card payment server so that payment is requested, and the VAN relay server checks the credit card information and transmits payment approval information delivered from the credit card payment server to the seller store terminal so that the payment is approved.

Such a conventional payment system based on a seller store terminal has the following limitations.

First, there is a limitation that a seller store cashier needs to determine a payment method by directly inquiring to a purchase payer about the payment method and then provide the purchase payer with a payment interface according to the determined payment method. That is, there is a hassle that the seller store cashier needs to directly check the payment method or payment service used by each purchase payer at each time of payment, which increases the time required for payment and causes an inconvenience in the payment process.

In addition, the existing seller store terminal has a limitation in interoperating with a mobile communication terminal, such as a smartphone or tablet PC, owned by a seller store cashier, or a universal operating system (OS) of the mobile communication terminal, so there is a need to improve convenience of payment through interoperability, and furthermore, when the payment method is a peer-to-peer (P2P) transfer method between a seller store and a purchase payer, the seller store is not provided with the convenience of confirming a receipt of the payment amount.

On the other hand, unlike the conventional method of a seller store terminal requesting payment, a recent trend is toward adopting a method of a payer terminal requesting payment by a payer terminal, in which a terminal of a payer recognizes an identification code (e.g., a quick response (QR) code) output on a seller store terminal to receive information required for payment, and directly requests payment from a payment server.

In such a payment terminal payment request method, the payment terminal has a risk of a security accident in which an identification code output from a seller store terminal is acquired by a payment terminal, the acquired identification code is changed into an identification code of a payer who is not the seller store (i.e., a malicious thief) or an identification code of another seller store, and payment is requested so that payment is transferred to an account of the thief or another seller store.

Such a security accident is caused by the absence of a system that checks whether an identification code of a seller store delivered from a purchase payer corresponds to an actual identification code output from a seller store terminal, so there is a need for a system that eliminates the security threat.

The background art of embodiments of the present invention, which are hereby incorporated by reference, is disclosed in Korean Laid-Open Patent Publication No. 10-2015-0042385 (Apr. 21, 2015).

### SUMMARY

An aspect relates to providing a payment interface device and system, a payment method, and a payment server that are capable of providing a method of removing a hassle that a seller store cashier directly inquires to a purchase payer about a payment method when performing payment in a seller store while interoperating a mobile communication terminal possessed by a seller store cashier with a seller store terminal so that convenience of payment is improved.

A further aspect relates to providing a payment interface device and system, a payment method, and a payment server that are capable of eliminating a security accident in which an identification code output from a seller store terminal is changed by a malicious thief and payment occurs so that the payment security is improved.

One aspect of embodiments of the present invention provides a payment interface device including: a seller interface unit configured to acquire a payer identifier, which is identification information of a payer who has purchased a product, from a payment terminal possessed by the payer, receive payment information of the payer to be matched with the acquired payer identifier, and request payment for the payer to a payment server on the basis of the input payment information; and a payer interface unit configured to be dividable from the seller interface unit and provide the payer with the payment information input into the seller interface unit.

The seller interface unit may receive the payment information through a method of outputting the payer identifier acquired from the payment terminal and receiving the payment information to be matched with the output payer identifier or through a method of converting the payer identifier acquired from the payment terminal into a payer identifier of a predetermined type, outputting the converted payer identifier, and receiving the payment information to be matched with the converted output payer identifier.

The seller interface unit may generate one or more service-linked payer identifiers for linking with one or more payment services on the basis of the acquired payer identifier and receive the payment information of the payer to be matched with a service-linked payer identifier selected by a seller among the generated one or more service-linked payer identifiers.

The seller interface unit may receive the payer identifier delivered from the payer interface unit that has acquired the payer identifier output on the payment terminal or directly receive the payer identifier from the payment terminal so that the seller interface unit may acquire the payer identifier.

Another aspect of embodiments of the present invention provides a payment interface system including: a first interface device configured to receive payment information of a payer who has purchased a product, generate a payment information identifier, which is identification information of the payment information, and transmit the payment information identifier such that a payment terminal possessed by the payer recognizes the generated payment information identifier and requests payment for the payer to a payment server; and a second interface device configured to acquire a payer identifier, which is identification information of the payer, from the payment terminal, receive the payment information of the payer to be matched with the acquired payer identifier, and request the payment for the payer to the payment server on the basis of the input payment information, wherein the first interface device and the second interface device are selectively operated when the payment for the payer proceeds.

Another aspect of embodiments of the present invention provides a payment interface system including a seller mobile communication terminal part including one or more mobile communication terminals, and a payer interface unit configured to be combinable with each of the one or more mobile communication terminals and provide a payer who has purchased a product with payment information of the payer that is input into each of the one or more mobile communication terminals, wherein each of the one or more mobile communication terminals, while in combination with the payer interface unit, acquires a payer identifier, which is identification information of the payer, from a payment terminal possessed by the payer, receives the payment information of the payer to be matched with the acquired payer identifier, and requests payment for the payer to a payment server on the basis of the input payment information.

The mobile communication terminal combined with the payer interface unit may receive a unique authentication identifier for terminal authentication required for performing the payment for the payer and delivered from the payer interface unit, request the terminal authentication to the payment server on the basis of the received unique authentication identifier, receive a result of the request, and perform the terminal authentication.

Another aspect of embodiments of the present invention provides a payment method using a payment interface system including a seller mobile communication terminal part including one or more mobile communication terminals and a payer interface unit configured to be combinable with each of the one or more mobile communication terminals and provide a payer who has purchased a product with payment information of the payer that is input into each of the one or more mobile communication terminals, the payment method including: acquiring, by the mobile communication terminal combined with the payer interface unit, a payer identifier, which is identification information of the payer, from a payment terminal possessed by the payer; receiving, by the mobile communication terminal combined with the payer interface unit, the payment information of the payer to be matched with the acquired payer identifier; and requesting, by the mobile communication terminal combined with the payer interface unit, payment for the payer to a payment server on the basis of the input payment information.

Another aspect of embodiments of the present invention provides a payment interface system including a seller mobile communication terminal part including one or more mobile communication terminals, and a payer interface unit configured to be combinable with each of the one or more mobile communication terminals and provide a payer who has purchased a product with payment information of the payer that is input into each of the one or more mobile communication terminals, wherein each of the one or more mobile communication terminals while in combination with the payer interface unit receives the payment information of the payer, generates a payment information identifier, which is identification information of the input payment information, and transmits the payment information identifier to the payer interface unit, and the payer interface unit transmits the payment information identifier such that a payment terminal possessed by the payer recognizes the payment information identifier and requests payment for the payer to a payment server.

Another aspect of embodiments of the present invention provides a payment method using a payment interface system including a seller mobile communication terminal part including one or more mobile communication terminals and a payer interface unit configured to be combinable with each of the one or more mobile communication terminals and provide a payer who has purchased a product with payment information of the payer that is input into each of the one or more mobile communication terminals, the payment method including, by the mobile communication terminal combined with the payer interface unit, receiving the payment information of the payer; generating a payment information identifier, which is identification information of the input payment information, and transmitting the generated payment information identifier to the payer interface unit, and by the payer interface unit, transmitting the payment information identifier such that a payment terminal possessed by the payer recognizes the payment information identifier and requests payment for the payer to a payment server.

Another aspect of embodiments of the present invention provides a payment server configured to: receive a first payer identifier, which is identification information of the payer, and a first seller store identifier, which is identification information of a seller store, from the seller interface unit; receive a second payer identifier and a second seller store identifier that match the first payer identifier and the first seller store identifier, respectively, from the payment terminal in a normal payment situation; and compare the first payer identifier and the first seller store identifier with the second payer identifier and the second seller store identifier, respectively, and only when it is determined that the first payer identifier and the first seller store identifier match the second payer identifier and the second seller store identifier, respectively, perform the payment for the payer on the basis of payment information of the payer.

The payment server may receive a modulated identifier that is generated by modulating the first seller store identifier by the payer interface unit and delivered through the payment terminal, and compare the second payer identifier and the second seller store identifier, which is extracted by demodulating the received modulated identifier, with the first payer identifier and the first seller store identifier, respectively.

The modulated identifier may reflect a time-based key corresponding to a point in time at which the modulated identifier is modulated by the payer interface unit, and the payment server may proceed with payment for the payer only when a value of the time-based key extracted by demodulating the modulated identifier is different from a value corresponding to a point in time at which the modulated identifier is demodulated within a preset allowable range while the second payer identifier and the second seller store identifier, which is extracted by demodulating the modulated identifier, match the first payer identifier and the first seller store identifier, respectively, as a result of the comparison.

The modulated identifier may be generated as a modulated sound wave in an inaudible band.

The payment server may receive the payment information of the payer that is delivered from one of the seller interface unit, the payer interface unit, and the payment terminal, thereby receiving a request of the payment for the payer.

Another aspect of embodiments of the present invention provides a payment method including: receiving, by the payment server, a first payer identifier, which is identification information of the payer, and a first seller store identifier, which is identification information of a seller store, from the seller interface unit; receiving, by the payment server, a second payer identifier and a second seller store identifier that match the first payer identifier and the first seller store identifier, respectively, from the payment terminal in a normal payment situation; and comparing, by the payment server, the first payer identifier and the first seller store identifier with the second payer identifier and the second seller store identifier, respectively, and only when it is determined that the first payer identifier and the first seller store identifier match the second payer identifier and the second seller store identifier, respectively, performing the payment for the payer on the basis of payment information of the payer.

Another aspect of embodiments of the present invention provides a payment interface device including: a seller interface unit configured to modulate a payer identifier, which is identification information of a payer who has purchased a product, payment information of the payer, and a seller store identifier, which is identification information of a seller store, to generate a modulated identifier; and a payer interface unit configured to transmit the modulated identifier delivered from the seller interface unit such that a payment terminal possessed by the payer recognizes the modulated identifier and requests payment for the payer to a payment server and thus the payment server demodulates the modulated identifier and performs the payment for the payer.

The payer may include a first payer and a second payer, and the payment terminal includes a first payment terminal and a second payment terminal possessed by the first payer and the second payer, respectively; the seller interface unit may modulate a first payer identifier, which is identification information of the first payer, payment information of the first payer, and the seller store identifier to generate a first modulated identifier and modulates a second payer identifier, which is identification information of the second payer, payment information of the second payer, and the seller store identifier to generate a second modulated identifier; and the payer interface unit may transmit the first and second modulated identifiers delivered from the seller interface unit such that the first and second payment terminals recognize the first and second modulated identifiers, respectively, and request payments for the first and second payers to the payment server and thus the payment server demodulates the first and second modulated identifiers and perform the payments for the first and second payers.

The payer interface unit may include a first payer interface unit and a second payer interface unit for performing payment according to a first payment service and payment according to a second payment service, respectively; the seller interface unit may modulate the payer identifier, the payment information, and the seller store identifier based on a protocol according to the first payment service to generate a first modulated identifier and modulate the payer identifier, the payment information, and the seller store identifier based on a protocol according to the second payment service to generate a second modulated identifier, and the payer interface unit may transmit the first and second modulated identifiers delivered from the seller interface unit such that a modulated identifier according to the payment service selected through the payment terminal between the first and second modulated identifiers is recognized, and payment for the payer is requested to the payment server according to the selected payment service.

Another aspect of embodiments of the present invention provides a payment method including: modulating, by the seller interface unit, a payer identifier, which is identification information of a payer who has purchased a product, payment information of the payer, and a seller store identifier, which is identification information of a seller store, to generate a modulated identifier; and transmitting, by the payer interface unit, the modulated identifier delivered from the seller interface unit such that a payment terminal possessed by the payer recognizes the modulated identifier and requests payment for the payer to a payment server and thus the payment server demodulates the modulated identifier and performs the payment for the payer.

According to aspects of embodiments of the present invention, a seller store terminal provided at a seller store is implemented to be divided into interface devices for a seller store cashier and an interface device for a purchase payer, so that the convenience of payment can be improved, and a system of confirming whether an identification code of a seller store delivered from a purchase payer corresponds to an actual identification code output from a seller store terminal is employed, so that payment security can be improved.

### BRIEF DESCRIPTION

Some of the embodiments will be described in detail, with reference to the following figures, wherein like designations denote like members, wherein:

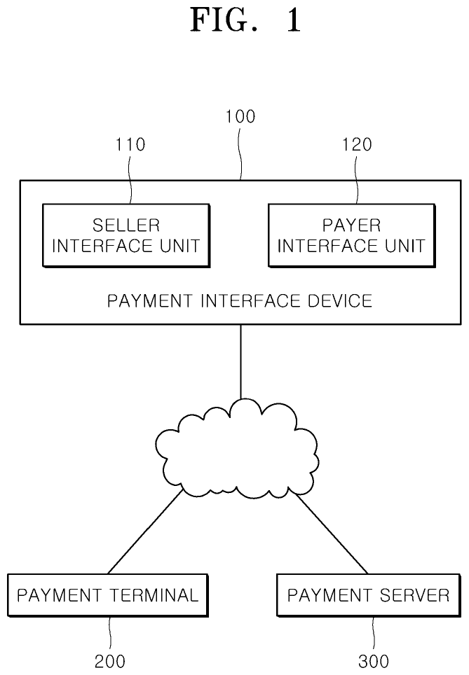

FIG. 1 is a block diagram illustrating a payment interface device according to the first embodiment of the present invention;

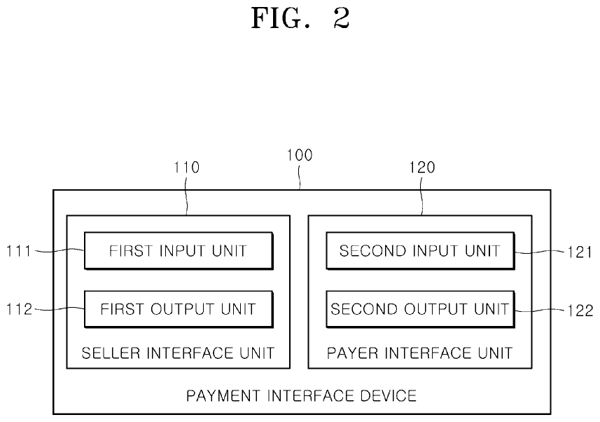

FIG. 2 is an exemplary diagram illustrating components included in the payment interface device according to the first embodiment of the present invention;

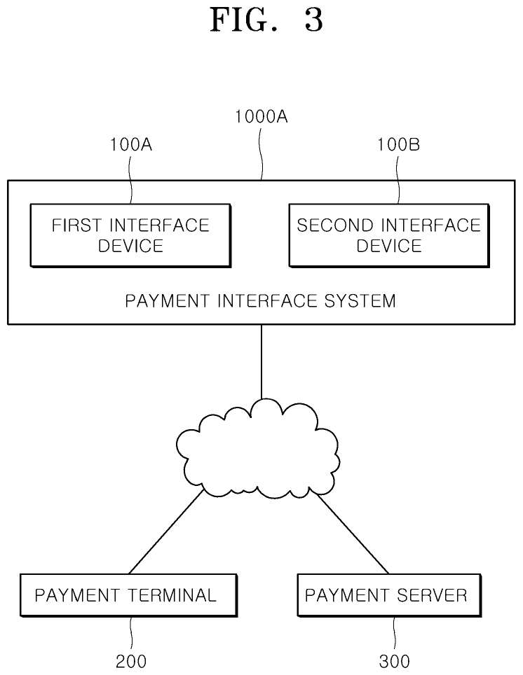

FIG. 3 is a block diagram illustrating a payment interface system according to the second embodiment of the present invention;

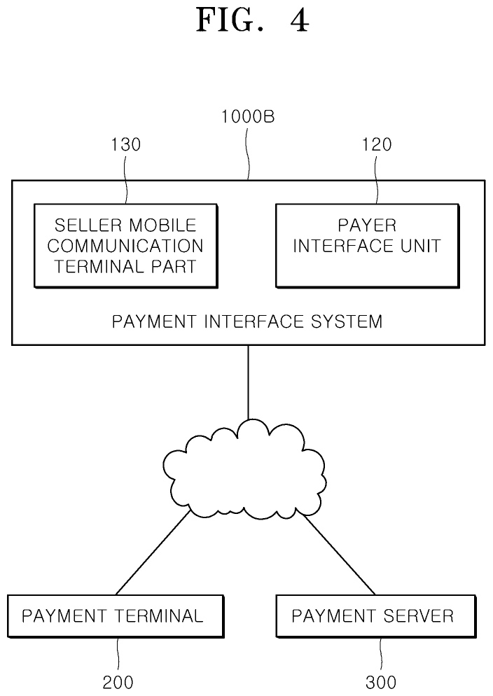

FIG. 4 is a block diagram for describing a payment interface system according to the third embodiment of the present invention;

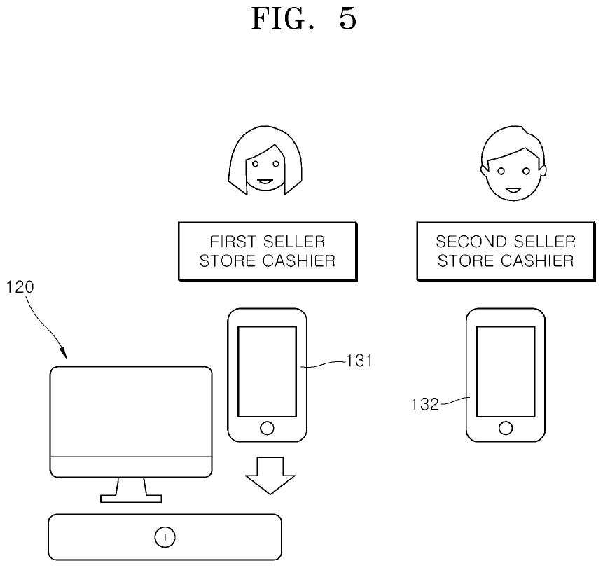

FIG. 5 is an exemplary diagram illustrating an implementation example of the payment interface system according to the third embodiment of the present invention;

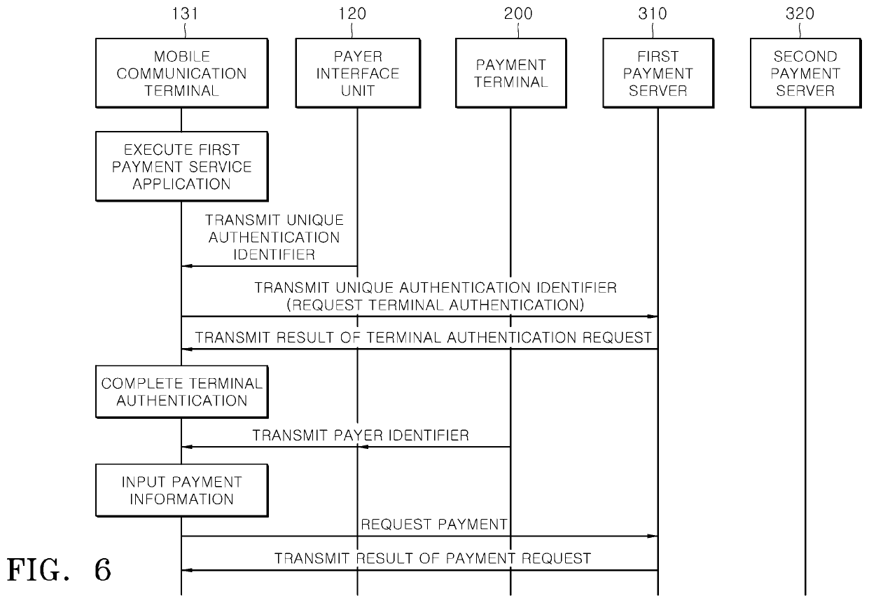

FIG. 6 is an exemplary diagram for describing an operation of the payment interface system (a method of requesting payment by a seller store terminal) according to the third embodiment of the present invention;

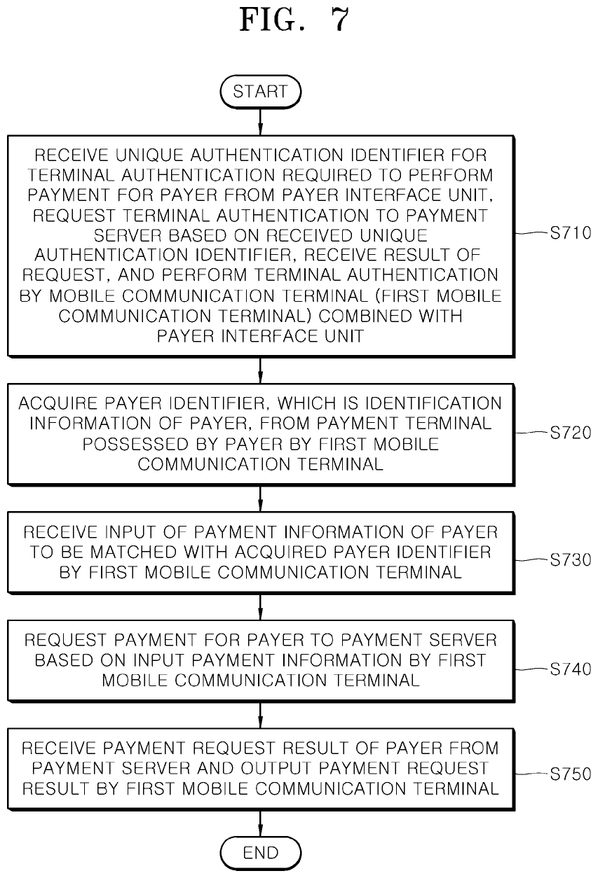

FIG. 7 is a flowchart for describing a payment method (a method of requesting payment by a seller store terminal) according to the third embodiment of the present invention;

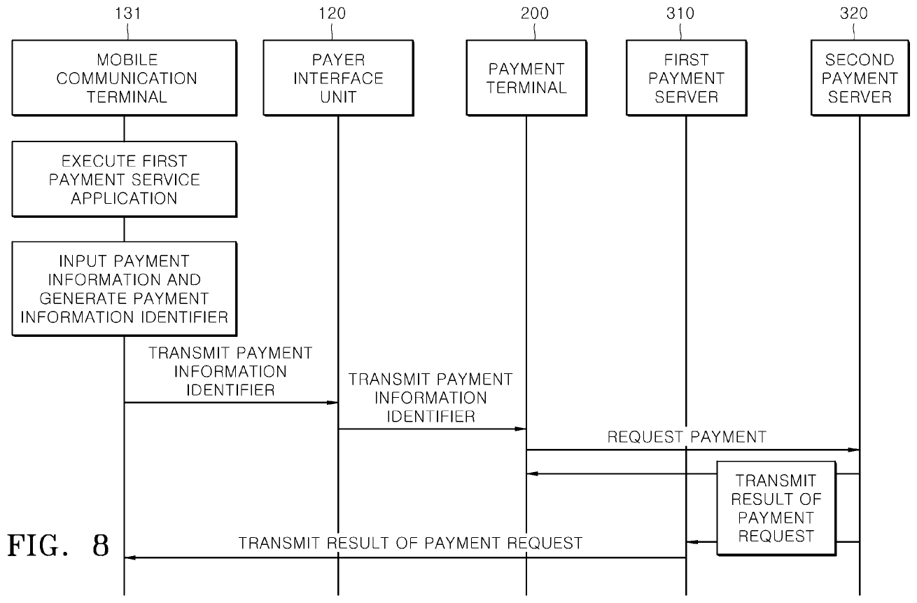

FIG. 8 is an exemplary diagram for describing an operation of the payment interface system payer terminal according to the third embodiment of the present invention (a method of requesting payment by a payer terminal);

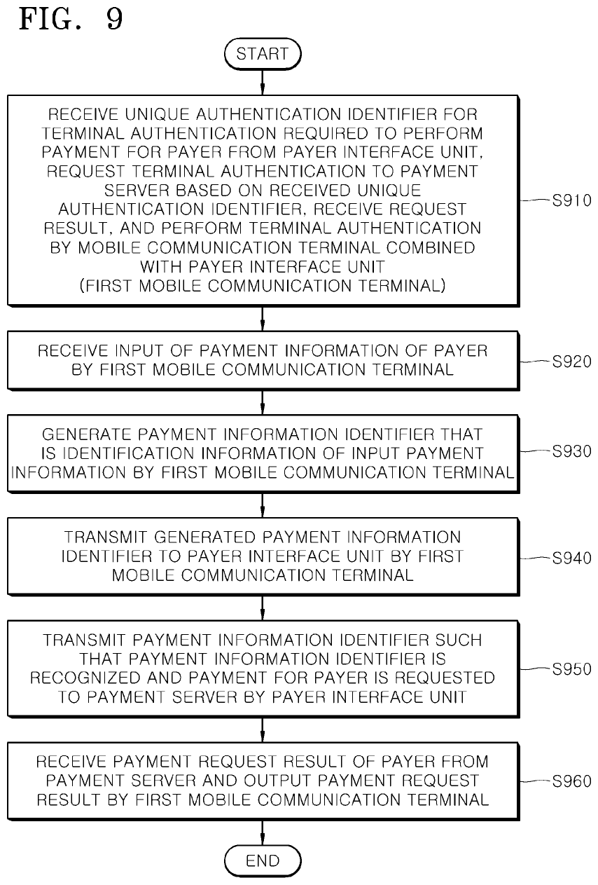

FIG. 9 is a flowchart for describing a payment method payment terminal according to the third embodiment of the present invention (a method of requesting payment by a payer terminal);

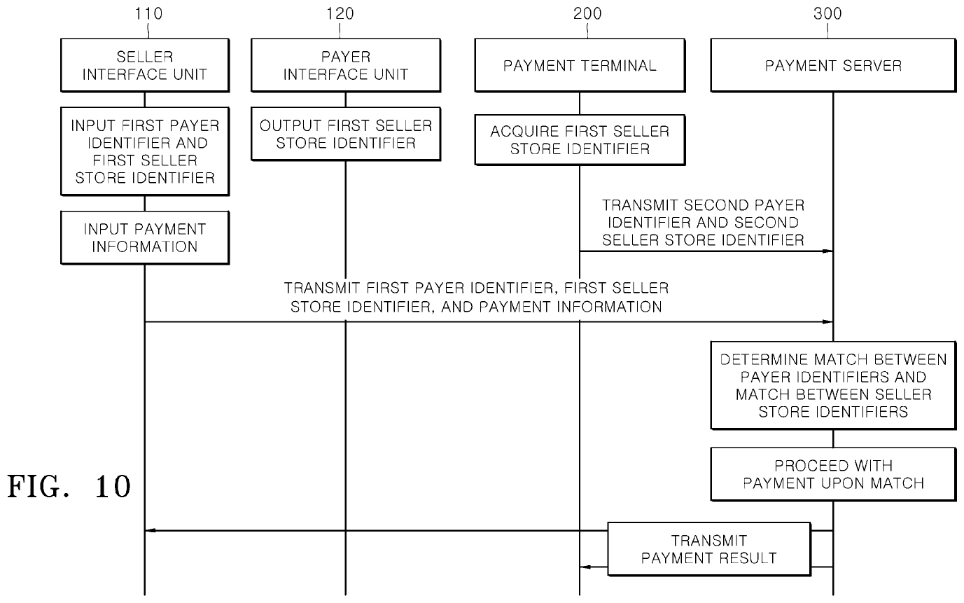

FIG. 10 is an exemplary diagram for describing an operation of a payment server according to the fourth embodiment of the present invention;

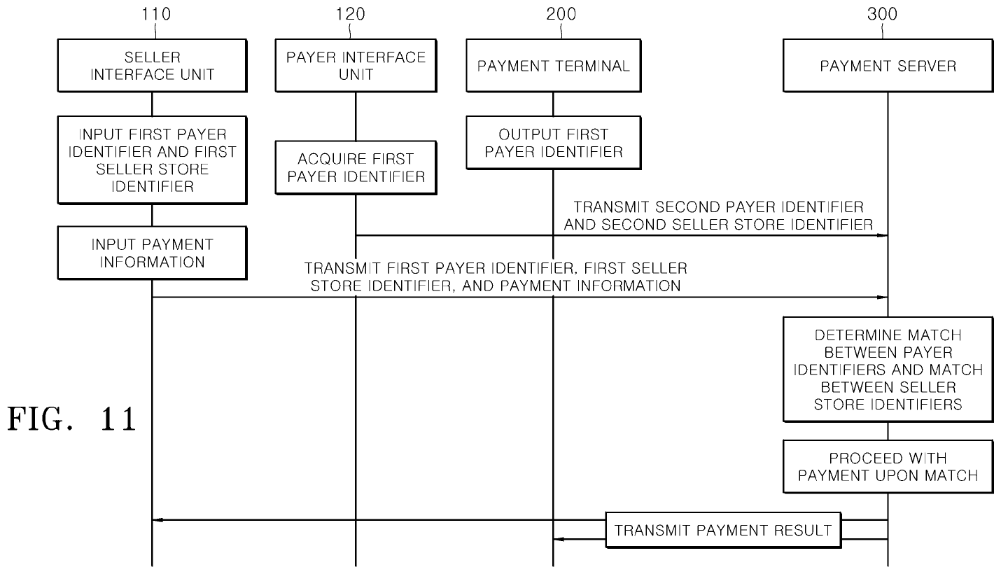

FIG. 11 is an exemplary diagram for describing an operation of a payment server according to the fourth embodiment of the present invention;

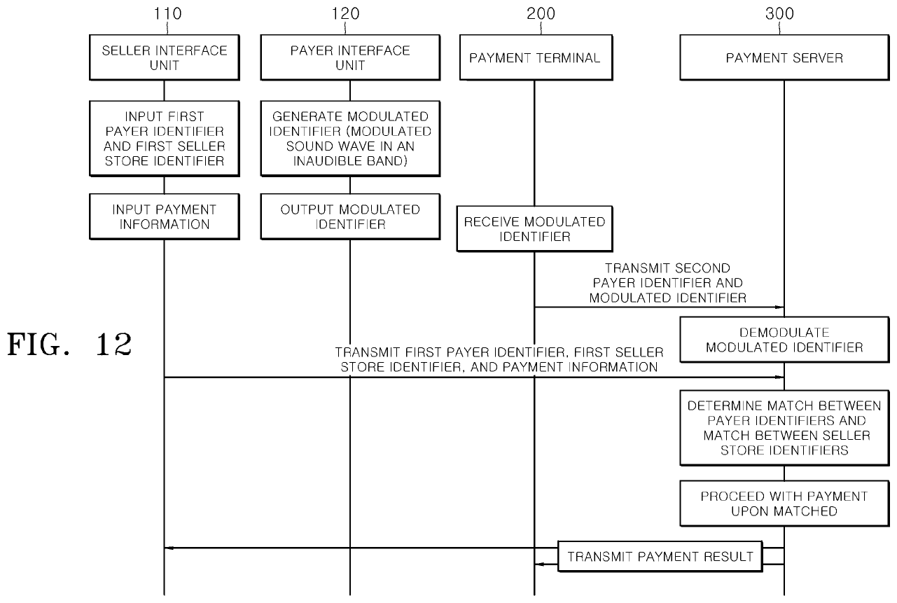

FIG. 12 is an exemplary diagram for describing an operation of a payment server according to the fourth embodiment of the present invention;

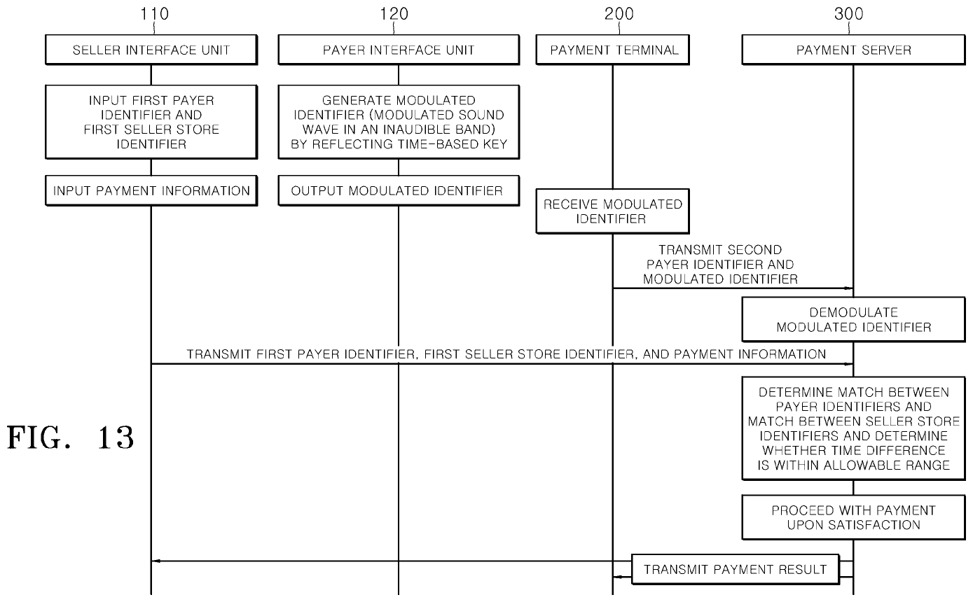

FIG. 13 is an exemplary diagram for describing an operation of a payment server according to the fourth embodiment of the present invention;

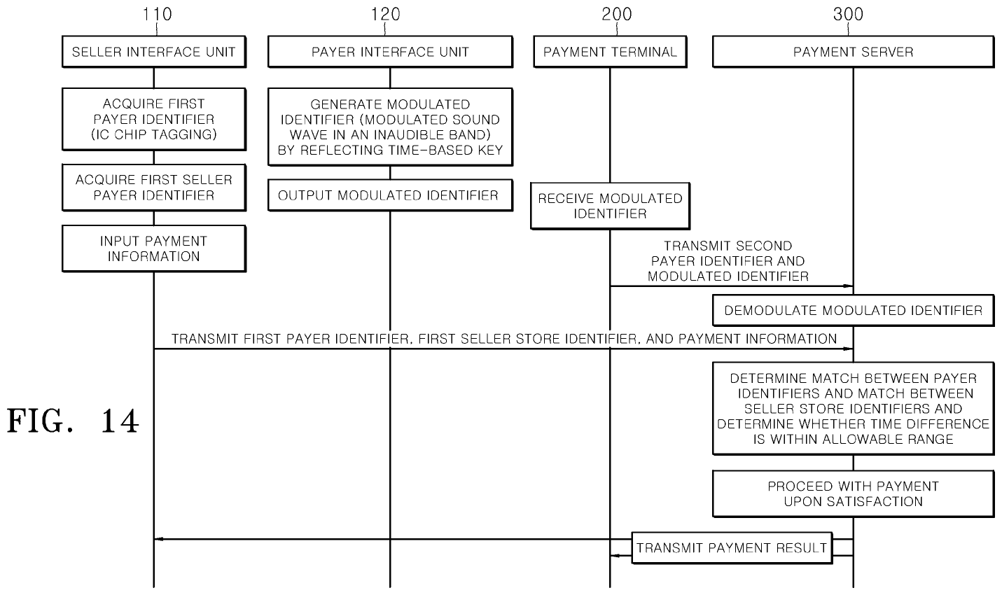

FIG. 14 is an exemplary diagram for describing an operation of a payment server according to the fourth embodiment of the present invention;

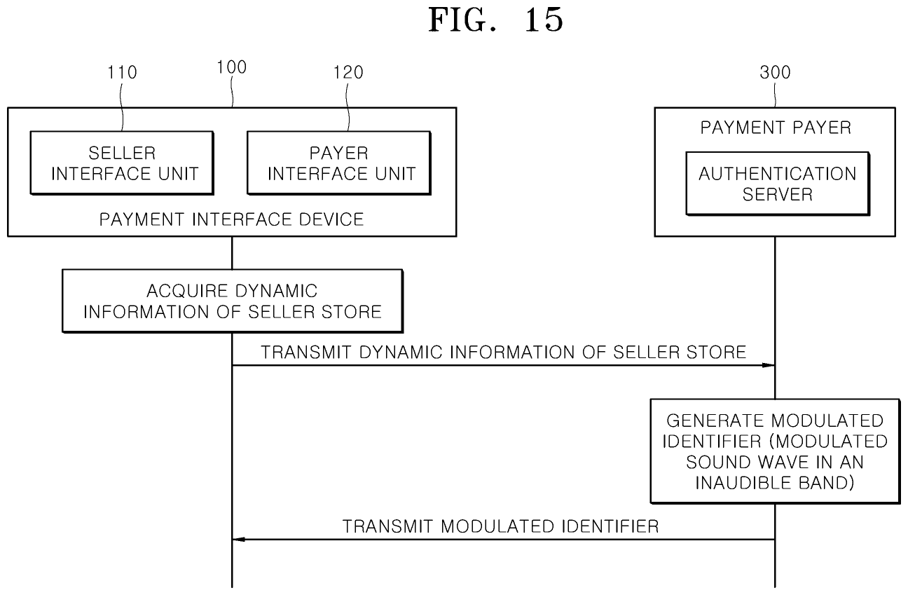

FIG. 15 is an exemplary diagram for describing an operation of a payment server according to the fourth embodiment of the present invention;

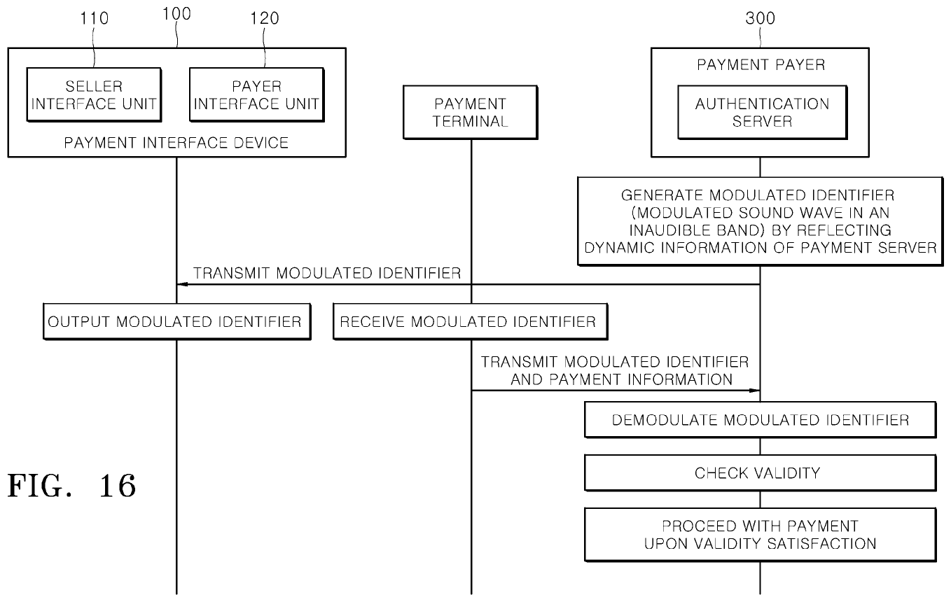

FIG. 16 is an exemplary diagram for describing an operation of a payment server according to the fourth embodiment of the present invention;

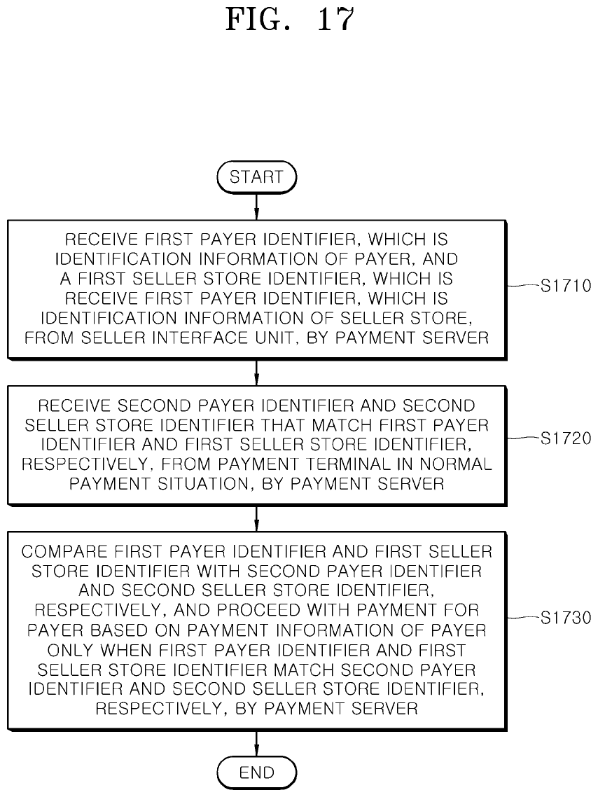

FIG. 17 is an exemplary diagram for describing a payment method according to the fourth embodiment of the present invention;

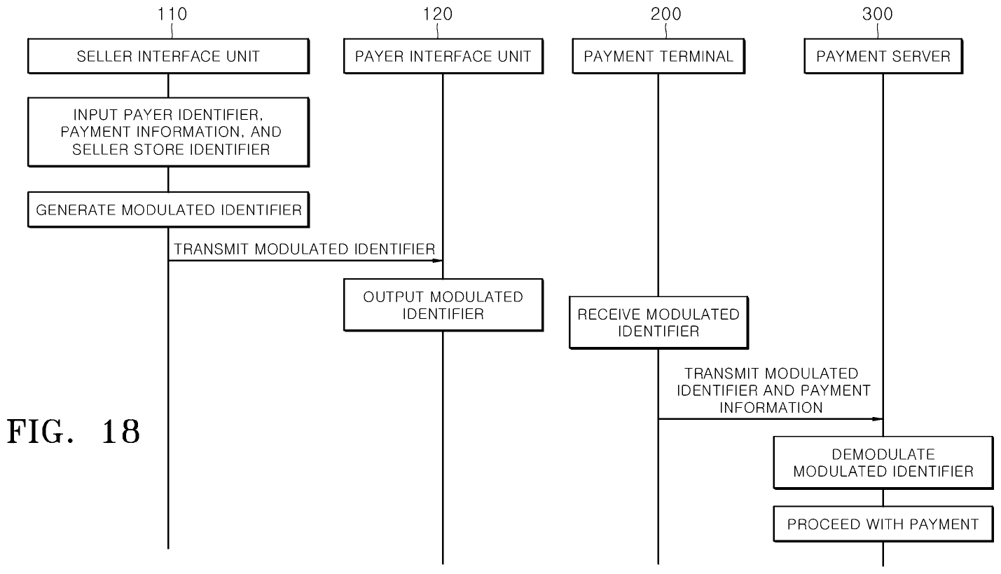

FIG. 18 is an exemplary diagram for describing an operation of a payment interface device according to the fourth embodiment of the present invention

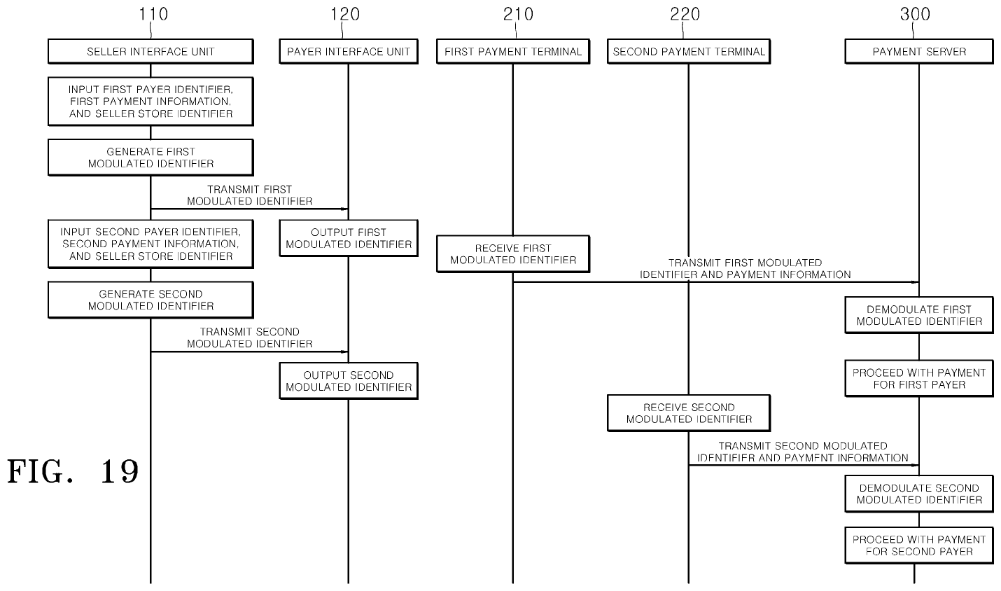

FIG. 19 is an exemplary diagram for describing an operation of a payment interface device according to the fourth embodiment of the present invention;

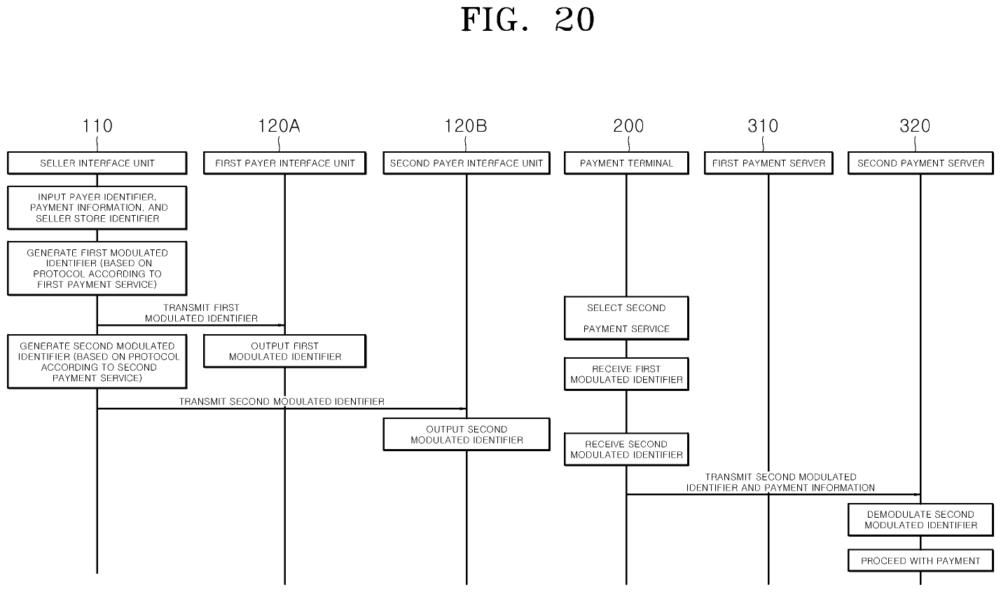

FIG. 20 is an exemplary diagram for describing an operation of a payment interface device according to the fourth embodiment of the present invention;

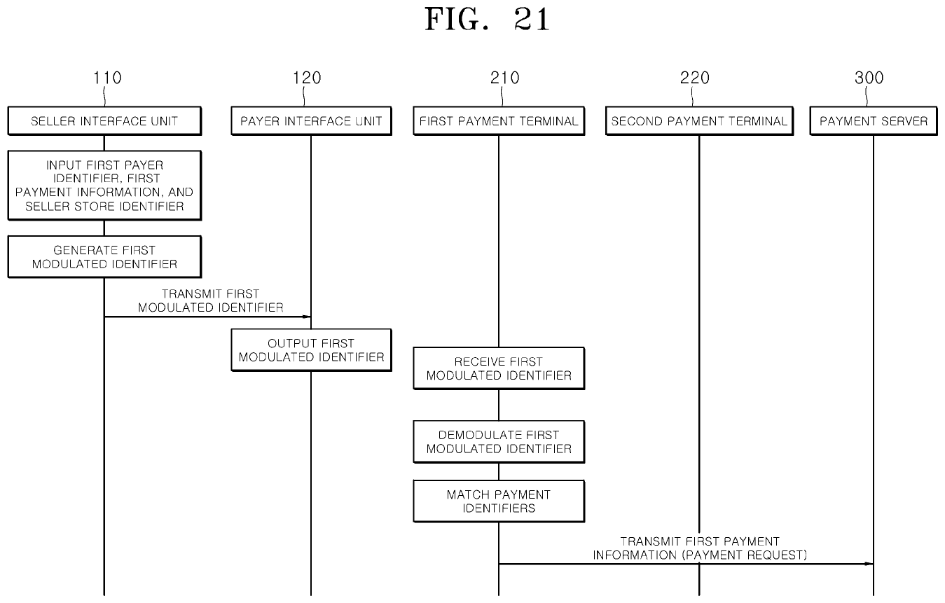

FIG. 21 is an exemplary diagram for describing an operation of a payment interface device according to the fourth embodiment of the present invention; and

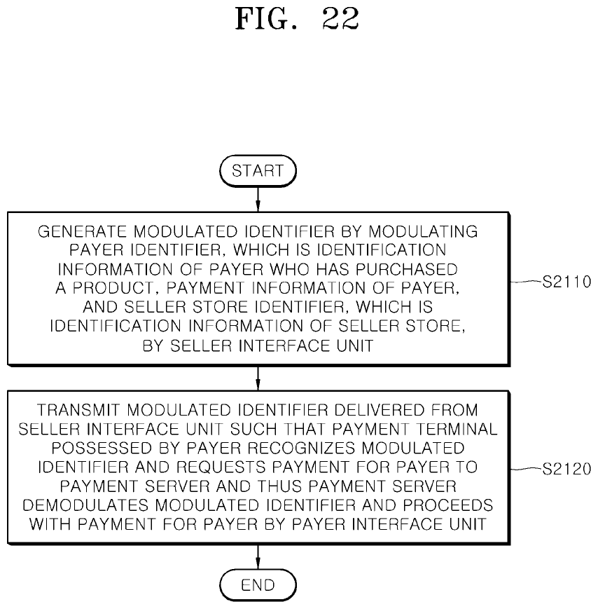

FIG. 22 is an exemplary diagram for describing a payment method according to the fourth embodiment of the present invention.

### DETAILED DESCRIPTION

Hereinafter, a payment interface device and system, a payment method, and a payment server according to embodiments of the present invention will be described in detail with reference to the accompanying drawings. The thickness of each line or the size of each component shown in the drawings may be exaggerated for the purpose of clarity and convenience. Although terms used herein are selected from among general terms that are currently and widely used in consideration of functions in the exemplary embodiments, these may be changed according to intentions or customs of those skilled in the art or the advent of new technology.

### First Embodiment

FIG. 1 is a block diagram illustrating a payment interface device according to the first embodiment of the present invention, and FIG. 2 is an exemplary diagram illustrating components included in the payment interface device according to the first embodiment of the present invention.

Referring to FIG. 1, a payment interface device 100 according to the first embodiment of the present invention may include a seller interface unit 110 and a payer interface unit 120 and may perform payment for a payer through communication with a payment terminal 200 and a payment server 300.

Referring to FIG. 2, as for the components included in the seller interface unit 110 and the payer interface unit 120, first, the seller interface unit 110 may include a first input unit 111 configured to receive payment information (order details and payment amount) of a payer who has purchased a product from a seller and a first output unit 112 configured to output the payment information input through the first input unit 111 together with a payer identifier delivered from the payer interface unit 120, which will be described below, to the seller. The first input unit 111 may include a keyboard, a scanner (e.g., a quick response (QR) code scanner, a barcode scanner, etc.), and a voice/sound wave recognition device (e.g., a microphone, etc.) for receiving payment information, and the first output unit 112 may include a display device (e.g., a liquid crystal display (LCD), etc.) and a voice/sound wave output device for outputting payment information and a payer identifier to a seller.

The payer interface unit 120 may include a second input unit 121 configured to receive a payer identifier from the payment terminal 200, which will be described below, and a second output unit 122 configured to provide the payment information input to the seller interface unit 110 so that a payer checks the payment information. The second input unit 121 may include a keyboard and a scanner (e.g., a QR code scanner, a barcode scanner, etc.) and a voice/sound wave recognition device (e.g., a microphone, etc.) to receive a payer identifier from the payment terminal 200. In addition, the second output unit 122 may include a display device (e.g., an LCD, etc.) and a voice/sound wave output device to output payment information to a payer.

The seller interface unit 110 and the payer interface unit 120 may be designed in a structure that the seller interface unit 110 and the payer interface unit 120 are separately coupled to each other, and when separately installed at a seller store, information may be transmitted and received through wired or wireless communication. For example, the seller interface unit 110 may be installed at a location where a seller store cashier resides, such as a cash register, and the payer interface unit 120 may be installed on a table (e.g., a restaurant table) where a payer is located, and the seller interface unit 110 and the payer interface unit 120 installed to be spaced apart from each other may transmit and receive information through wired or wireless communication.

Based on the above-described components included in the seller interface unit 110 and the payer interface unit 120, operations of the seller interface unit 110 and the payer interface unit 120 will be described below in detail.

The seller interface unit 110 may acquire a payer identifier (a QR code, a barcode, or short-range wireless communication (near field communication (NFC), and Bluetooth) data, etc.), which is identification information of a payer who has purchased a product, from the payment terminal 200 possessed by the payer, receive payment information of the payer to be matched with the acquired payer identifier, and request payment for the payer to the payment server 300 based on the input payment information.

First, as for an embodiment in which the seller interface unit 110 acquires the payer identifier, the seller interface unit 110 may receive the payer identifier delivered from the payer interface unit 120 which has acquired the payer identifier output on the payment terminal 200.

That is, the payer interface unit 120 may acquire a payer identifier output on the payment terminal 200 through the second input unit 121 (e.g., a QR code scanner or a barcode scanner), and the seller interface unit 110 may receive the payer identifier delivered from the payer interface unit 120 through wired/wireless communication and output the payer identifier through the first output unit 112. This may apply to a case in which the payment terminal 200 is capable of generating a payer identifier only in the form of a QR code or barcode due to the limitation of the protocol.

In addition, the seller interface unit 110 may receive the payer identifier transmitted directly from the payment terminal 200 without passing through the payer interface unit 120 and output the payer identifier through the first output unit 112. This may apply to a case in which the payment terminal 200 supports a short-range wireless communication protocol and generates a payer identifier in the form of short-range wireless communication data.

After acquiring the payer identifier, the seller interface unit 110 may receive the payment information of the payer to be matched with the acquired payer identifier and request payment to the payment server 300 based on the input payment information.

In other words, after the payer transmits the payer identifier to the seller interface unit 110 through the payment terminal 200 (via the payer interface unit 120 or directly), a seller store casher inputs payment information into the seller interface unit 110 such that the payment information matches with the payer identifier while scanning the payer identifier output through the first output unit 112 so that the seller interface unit 110 requests payment for the payer to the payment server 300 based on the input payment information. Accordingly, from the perspective of the seller store cashier, the inconvenience of manually scanning and recognizing the payer identifier, such as a QR code or barcode output on the payment terminal 200, is removed, and from the perspective of the payer, the payer identifier is transmitted to the seller interface unit 110 in a simple method of tagging the payer identifier to the first input unit 111 of the payer interface unit 120 installed on the table where the payer is located without needing to directly present the payment terminal 200 to the seller store cashier.

Meanwhile, in the present embodiment, the seller interface unit 110 may receive the payment information through a method of outputting the payer identifier acquired from the payment terminal 200 and receiving the payment information to be matched with the output payer identifier or through a method of converting the payer identifier acquired from the payment terminal 200 into a payer identifier of a predetermined type, outputting the converted payer identifier, and receiving the payment information to be matched with the converted output payer identifier.

That is, the seller interface unit 110 may receive the payer identifier delivered from the payer interface unit 120 that has acquired the payer identifier from the payment terminal 200 and directly output the payer identifier through the first output unit 112, or in response to presence of a plurality of payers, in consideration of the variety of payer identifier generation protocols supported by respective payment terminals possessed by the payers, the seller interface unit 110 may receive the payer identifier delivered from the payer interface unit 120 that has acquired the payer identifier from the payment terminal 200, convert the received payer identifier into a payer identifier of a predetermined type, and output the converted payer identifier through the first output unit 112.

For example, even when the payment terminal 200 possessed by the payer transmits different types of payer identifiers, such as a QR code, a barcode, or short-range wireless communication (NFC, Bluetooth, etc.) data, the seller interface unit 110 may convert the different types of payer identifiers into a payer identifier of a predetermined type (e.g., a barcode) and output the converted payer identifier through the first output unit 112. Accordingly, the seller store cashier may input payment information by tagging the payer identifier through a scanning device of one type with respect to the various payer identifiers.

On the other hand, the seller interface unit 110 may generate one or more service-linked payer identifiers for linking with one or more payment services on the basis of the acquired payer identifier and may receive payment information of the payer to be matched with a service-linked payer identifier selected by the seller among the generated one or more service-linked payer identifiers.

For example, when the seller interface unit 110 acquires a payer identifier according to a payment service of A Pay (e.g., a card company) from the payment terminal 200, the seller interface unit 110 may generate service-linked payer identifiers, such as a payer identifier according to the A Pay payment service, a payer identifier according to a payment service of B Bank (e.g., a bank company), a payer identifier according to a C payment integrated relay service, a payer identifier according to an electronic payment settlement agency service, a payer identifier according to a VAN service, and a payer identifier according to an electronic financial assistant service, output the generated payer identifiers, and receive payment information to be matched with a service-linked payer identifier selected by the seller store cashier among the output service-linked payer identifiers. Accordingly, the seller store cashier may perform payment for the payer according to a desired payment method.

Through the first embodiment, the payment interface device 100 provided at the seller store is implemented to be divided into the seller interface unit 110 for a seller store cashier and the payer interface unit 120 for a payer so that the inconvenience of a seller store cashier directly checking the payment method from the purchase payer at a time of payment in a seller store is removed, thereby improving the convenience of payment.

### Second Embodiment

FIG. 3 is a block diagram illustrating a payment interface system according to the second embodiment of the present invention.

Referring to FIG. 3, a payment interface system 1000A according to the second embodiment of the present invention may include a first interface device 100A and a second interface device 100B and perform payment for a payer through communication with a payment terminal 200 and a payment server 300.

In the second embodiment, the first interface device 100A and the second interface device 100B may include the same configuration and perform the same functions as those of the payment interface device 100 described in the first embodiment, and additionally the seller interface unit 110 of the first interface device 100A may further include a payment identifier generation unit together with the first input unit 111 and the first output unit 112 described in the first embodiment. The payment identifier generation unit may generate a payment information identifier (e.g., a QR code, a barcode, a character string, or an inaudible modulated sound wave signal), which is identification information of payment information input through the first input unit 111.

Based on the above description, operations of the first interface device 100A and the second interface device 100B will be described in detail.

The first interface device 100A may receive payment information of a payer who has purchased a product, generate a payment information identifier that is identification information of the payment information, and transmit the payment information identifier so that a payment terminal 200 possessed by the payer recognizes the generated payment information identifier and requests payment for the payer to the payment server 300.

Based on the contents of the first embodiment, an example of the operation of the first interface device 100A will be described. The seller interface unit 110 of the first interface device 100A may receive payment information of a payer from a seller store cashier through the first input unit 111, generate a payment information identifier through the payment identifier generation unit, and transmit the generated payment information identifier to the payer interface unit 120, and the payer interface unit 120 may output the payment information identifier through the second output unit 122 such that the payment terminal 200 recognizes the payment information identifier and requests payment for the payer to the payment server 300.

The second interface device 100B may acquire a payer identifier, which is identification information of a payer, from the payment terminal 200, receive payment information of the payer to be matched with the acquired payer identifier, and request payment for the payer to the payment server 300 based on the input payment information.

Based on the contents of the first embodiment, an example of the operation of the second interface device 100B will be described. The seller interface unit 110 of the second interface device 100B may acquire a payer identifier (via the payer interface unit 120 or directly), receive payment information of the payer through the first input unit 111 such that the payment information is matched with the acquired payer identifier, and request payment for the payer to the payment server 300 on the basis of the input payment information.

That is, the second embodiment is an embodiment in which the first interface device 100A uses a method of requesting payment by a payer terminal, and the second interface device 100B uses a method of requesting payment by a seller store terminal. In this case, the first interface device 100A and the second interface device 100B may selectively operate when payment for a payer is performed.

As a specific example, the first interface device 100A uses a method of requesting payment by a payer terminal in which a payment information identifier, such as a QR code, is output such that the payment terminal 200 requests payment to the payment server 300, and the second interface device 100B uses a method of requesting payment by a seller store terminal in which payment is requested to the payment server 300 on the basis of payment information that is input to be matched with a payer identifier, such as a bar code, acquired from the payment terminal 200 possessed by the payer.

Through the second embodiment, from the perspective of the seller store, both a method of requesting payment by a payer terminal and a method of requesting payment by a seller store terminal are supported without limitation to a payment request method performable by a payer, and from the perspective of the payer, an interface device using a desired payment request method may be freely selected by the payer and payment may be performed, and thus the convenience of payment may be improved.

### Third Embodiment

FIG. 4 is a block diagram for describing a payment interface system according to the third embodiment of the present invention, FIG. 5 is an exemplary diagram illustrating an implementation example of the payment interface system according to the third embodiment of the present invention, and FIG. 6 is an exemplary diagram for describing an operation of the payment interface system (a method of requesting payment by a seller store terminal) according to the third embodiment of the present invention.

Referring to FIG. 4, a payment interface system 1000B according to the third embodiment of the present invention may include a seller mobile communication terminal part 130 and a payer interface unit 120, and the seller mobile communication terminal part 130 may include one or more mobile communication terminals for payment processing at a seller store. The payment interface system 1000B may perform payment for a payer through communication with the payment terminal 200 and the payment server 300.

The third embodiment is an embodiment in which the seller interface unit 110 is replaced by each mobile communication terminal included in the seller mobile communication terminal part 130, and the third embodiment suggests a method of interoperating a seller store terminal (i.e., the payer interface unit 120 in the third embodiment) with a mobile communication terminal, such as a smartphone or tablet PC, possessed by a cashier of a seller store or with a general OS of the mobile communication terminal.

To this end, the payer interface unit 120 may have an OS installed thereon that is the same as that of the mobile communication terminal such that a payment service application distributed in the form of software running on an OS (e.g., Android OS) installed in each mobile communication terminal is installed and operated in the payer interface unit 120. For example, the same OS as that installed in the mobile communication terminal may be installed in the payer interface unit 120 so that a Bank application A, a Bank application B, or a Pay application C operating in the OS installed in the mobile communication terminal may interoperate with the payer interface unit 120.

Further, in the third embodiment, in order to clarify an entity that has replaced the seller interface unit 110, the entity is indicated as a “mobile communication terminal,” and any terminal installed with an application that provides functions performed by the mobile communication terminal described below may serve as the mobile communication terminal according to the third embodiment. For example, not only a dedicated terminal manufactured by a terminal manufacturer but also a general-purpose terminal (e.g., an Android smartphone), may serve as the mobile communication according to the third embodiment as long as the application is installed thereon.

Based on the above description, an operation of the payment interface system 1000B according to the third embodiment will be described in detail.

The payer interface unit 120 may be combined with each mobile communication terminal included in the seller mobile communication terminal part 130 and may provide a payer who has purchased a product with payment information of the payer that is input into each mobile communication terminal.

Each mobile communication terminal included in the seller mobile communication terminal part 130, while in combination with the payer interface unit 120, may acquire a payer identifier, which is identification information of the payer, from the payment terminal 200 possessed by the payer, receive payment information of the payer to be matched with the acquired payer identifier, and request payment for the payer to the payment server 300 based on the input payment information.

Referring to FIG. 5, as a specific example, in response to presence of a plurality of cashiers of a seller store, mobile communication terminal 131 and 132 possessed by the cashiers of the seller store form the seller mobile communication terminal part 130, and when a first mobile communication terminal 131 possessed by a first seller store cashier is combined with the payer interface unit 120, the first mobile communication terminal 131 may perform the same function as the payment interface device 100 described in the first embodiment. Accordingly, the first mobile communication terminal 131, while in combination with the payer interface unit 120, may acquire a payer identifier from the payment terminal 200 possessed by the payer (via the payer interface unit 120 or directly), receive payment information of the payer through an input unit (e.g., an input button or touch panel) provided in the first mobile communication terminal 131 such that the payment information is matched with the acquired payer identifier, and request payment for the payer to the payment server 300 based on the input payment information.

In this case, since a plurality of mobile communication terminals are combinable with the payer interface unit 120, authentication for a mobile communication terminal combined with the payer interface unit 120 is required in order to perform payment for the payer.

Accordingly, the mobile communication terminal combined with the payer interface unit 120 in the present embodiment may receive a unique authentication identifier for terminal authentication required to perform payment for the payer from the payer interface unit 120, request terminal authentication to the payment server 300 based on the received unique authentication identifier, receive a result of the request, and perform terminal authentication. On each mobile communication terminal included in the seller mobile communication terminal part 130 and the payer interface unit 120, a dedicated application for transmitting and receiving a unique authentication identifier and performing payment may be installed in a pre-authenticated state for each payment service. Accordingly, based on the dedicated application, the unique authentication identifier is transmitted and received, terminal authentication is performed through the payment server 300, and then payment is performed so that an external mobile communication terminal is prevented from being combined with the payer interface unit 120 and performing payment.

Referring to FIG. 6, a specific example of the above-described embodiment will be described. The mobile communication terminal combined with the payer interface unit 120 executes a first payment service application by manipulation of a cashier of the seller store, requests terminal authentication by transmitting a unique authentication identifier received from the payer interface unit 120 to a first payment server 310 according to a first payment service, and completes terminal authentication by receiving a result of request for the terminal authentication from the first payment server 310. In addition, the mobile communication terminal acquires a payer identifier from the payment terminal 200 possessed by the payer through the payer interface unit 120, receives payment information of the payer to be matched with the acquired payer identifier, and requests payment for the payer to the first payment server 310 based on the input payment information. Thereafter, the mobile communication terminal receives a result of the payment request from the first payment server 310 and outputs the result of the payment request.

FIG. 7 is a flowchart of describing a payment method (a method of requesting payment by a seller store terminal) according to the third embodiment of the present invention.

Referring to FIG. 7, a payment method (a method of requesting payment by a seller store terminal) according to the third embodiment of the present invention will be described. First, a mobile communication terminal (hereinafter, referred to as a first mobile communication terminal) combined with the payer interface unit 120 receives a unique authentication identifier for terminal authentication required to perform payment for a payer from the payer interface unit 120, requests terminal authentication to the payment server 300 based on the received unique authentication identifier, receives a result of the request, and performs terminal authentication (S710).

Subsequently, the first mobile communication terminal acquires a payer identifier, which is identification information of the payer, from the payment terminal 200 possessed by the payer (S720).

Subsequently, the first mobile communication terminal receives payment information of the payer to be matched with the payer identifier acquired in operation S720 (S730).

Subsequently, the first mobile communication terminal requests payment for the payer to the payment server 300 based on the payment information input in operation S730 (S740).

Subsequently, the first mobile communication terminal receives a result of the request of payment for the payer from the payment server 300 and outputs the payment request result (S750).

Meanwhile, the payment method according to the above-described embodiment may be written as a computer program for executing operations S720 to S740 while in combination with hardware and may be stored in a medium and implemented in hardware that operates the computer program. That is, the above-described payment method may be written as a computer program for executing operation S720 of acquiring a payer identifier, which is identification information of a payer, from the payment terminal 200 possessed by the payer, operation S730 of receiving payment information of the payer to be matched with the payer identifier acquired in operation S720, and operation S740 of requesting payment for the payer to the payment server 300 based on the payment information input in operation S730, and may be implemented in hardware combined therewith (In addition, the above-described payment method may be written as a computer program for further performing operations S710 and S750). The medium in which the computer program may include a read only memory (ROM), a random-access memory (RAM), a compact disc read only memory (CD-ROM), a magnetic tape, a floppy disk, an optical data storage device, and the like.

In the above, the third embodiment has been described as an embodiment according to a method of requesting payment by a seller store terminal, but the third embodiment may be implemented as an embodiment according to a method of requesting payment by a payer terminal.

That is, each mobile communication terminal included in the seller mobile communication terminal part 130, while in combination with the payer interface unit 120, may receive payment information of a payer, generate a payment information identifier, which is identification information of the input payment information (while each mobile communication terminal may have a dedicated application for generating a payment information identifier installed thereon), and transmit the generated payment information identifier to the payer interface unit 120. In addition, the payer interface unit 120 may transmit (output) the payment information identifier such that the payment terminal 200 possessed by the payer recognizes the payment information identifier and requests payment for the payer to the payment server 300. Accordingly, the payment terminal 200 may acquire the payment information identifier output by the payer interface unit 120 (such as by tagging a barcode or a QR code output by the second output unit 122 of the payer interface unit 120), and request payment for the payer to the payment server 300.

FIG. 8 is an exemplary diagram for describing an operation of the payment interface system (a method of requesting payment by a payer terminal) according to the third embodiment of the present invention. Referring to FIG. 8, a specific example of the above described embodiment will be described. The mobile communication terminal combined with the payer interface unit 120 executes the first payment service application by a manipulation of a cashier of a seller store.

In addition, the mobile communication terminal combined with the payer interface unit 120 may receive payment information of a payer, generate a payment information identifier, which is identification information of the input payment information, and transmit the payment information identifier to the payer interface unit 120. Thereafter, the payer interface unit 120 may transmit (output) the payment information identifier such that the payment terminal 200 possessed by the payer recognizes the payment information identifier and requests payment for the payer to the payment server 300. Accordingly, the payment terminal 200 may acquire the payment information identifier output by the payer interface unit 120 and request payment for the payer to the payment server 300.

Meanwhile, a payment service (a payment service for receiving a payment amount of a purchaser or performing post-settlement) used by each mobile communication terminal included in the seller mobile communication terminal part 130 may be different from a payment service used by the payment terminal 200 possessed by the payer. For example, the seller store may unify the payment method as much as possible when various payment services operate, and the present embodiment, which employs a mobile communication terminal, may facilitate payment processing based on an application installed in the mobile communication terminal when a payment service of a seller store is different than that of a payer.

As a specific example, when each mobile communication terminal uses the first payment service and the payment terminal 200 uses the second payment service, the cashier of the seller store executes the first payment service application installed in the mobile communication terminal. In this case, when payment is desired to be performed through a payment service used by the mobile communication terminal, i.e., the first payment service, a method of requesting payment by a seller store terminal may be operated such that the mobile communication terminal acquires a payer identifier from the payment terminal 200 and requests payment to the first payment server 310 together with payment information of the payer, and a method of requesting payment by a payer terminal may operate such that the payment terminal 200 acquires a payment information identifier output from the payer interface unit 120 and requests payment to a second payment server 320 together with the payment information of the payer. In this case, the seller interface unit 110 may receive the payment request result of the second payment server 320 through the first payment server 310 (see FIG. 8). Further, in the method of requesting payment by a payer terminal, the payment information identifier output from the payer interface unit 120 may be a payment information identifier based on a protocol of an integrated relay service, and accordingly, after the payment is completed, the payment amount may be deposited to the seller store or settled according to the first payment service through the integrated relay service.

FIG. 9 is a flowchart for describing a payment method (a method of requesting payment by a payer terminal) according to the third embodiment of the present invention.

Referring to FIG. 9, the payment method (a method of requesting payment by a payer terminal) according to the third embodiment of the present invention will be described. First, a mobile communication terminal combined with the payer interface unit 120 (hereinafter, a first mobile communication terminal) receives a unique authentication identifier for terminal authentication required to perform payment for the payer from the payer interface unit 120, requests terminal authentication to the payment server 300 based on the received unique authentication identifier, receives the request result, and performs terminal authentication (S910).

Subsequently, the first mobile communication terminal receives payment information of the payer (S920), generates a payment information identifier that is identification information of the input payment information (S930), and then transmits the generated payment information identifier to the payer interface unit 120 (S940).

Subsequently, the payer interface unit 120 transmits the payment information identifier such that the payment terminal 200 possessed by the payer recognizes the payment information identifier and requests payment for the payer to the payment server 300 (S950).

Subsequently, the first mobile communication terminal receives a payment request result for the payer from the payment server 300 and outputs the payment request result (S960).

### Fourth Embodiment

As described above, the method of requesting payment by a payer terminal has a risk of a security accident in which the payer terminal acquires an identification code output from the seller store terminal, converts the identification code into an identification code of a payer who is not the seller (i.e., a malicious thief) or an identification code of another seller, and requests payment, and thus payments may be transferred to an account of the thief or the other seller.

Accordingly, the present embodiment suggests a method of improving the payment security by employing a system for checking whether a seller store identifier transmitted from the payment terminal 200 corresponds to an actual seller store identifier output from the payment interface device 100 based on the operation of the payment server 300.

FIGS. 10 to 16 are exemplary diagrams for describing an operation of the payment server 300 according to the fourth embodiment of the present invention.

The payment server 300 according to the fourth embodiment may proceed with payment for a payer who has purchased a product by communicating with a payment interface device 100 including a seller interface unit 110 and a payer interface unit 120 and a payment terminal 200 possessed by the payer.

Specifically, first, the payment server 300 may receive a first payer identifier, which is identification information of the payer, and a first seller store identifier, which is identification information of a seller store, from the seller interface unit 110 (herein, the first payer identifier and the first seller store identifier are defined as referring to a payer identifier and a seller store identifier delivered from the seller interface unit 110, and a second payer identifier and a second seller store identifier to be described below are defined as referring to a payer identifier and a seller store identifier delivered from the payment terminal 200).

The first seller store identifier may be stored in the seller interface unit 110, or the first seller store identifier, which has been stored in the payer interface unit 120, may be transmitted to the seller interface unit 110 (a method of acquiring the first payer identifier by the seller interface unit 110 will be described below).

Accordingly, the payment server 300 may receive the first payer identifier and the first seller store identifier from the seller interface unit 110.

In addition, the payment server 300 may receive a second payer identifier and a second seller store identifier, which match the first payer identifier and the first seller store identifier, respectively, from the payment terminal 200 in a normal payment situation.

Here, as described above, the first seller store identifier may be stored in the payer interface unit 120, and accordingly, the payment terminal 200 may acquire the first seller store identifier output through the second output unit 122 of the payer interface unit 120 for a payer by tagging the first seller store identifier and transmit the acquired first seller store identifier to the payment server 300 as a second seller store identifier.

In a normal payment situation (i.e., a situation in which the payer identifier and the seller store identifier have not been changed by a malicious thief), the first payer identifier and the first seller store identifier need to match the second payer identifier and the second seller store identifier, respectively, and when the first payer identifier and the second payer identifier are different from each other, or the first seller store identifier and the second seller store identifier are different from each other, the case is considered a situation in which the payer identifier or the seller store identifier has been changed by a malicious thief.

Therefore, the payment server 300 may compare the first payer identifier and the first seller store identifier with the second payer identifier and the second seller store identifier, respectively, and proceed with payment for the payer based on payment information of the payer only when the first payer identifier and the first seller store identifier match the second payer identifier and the second seller store identifier, respectively. Here, the payment server 300 may receive a request of payment for the payer by receiving the payment information of the payer from one of the seller interface unit 110, the payer interface unit 120, and the payment terminal 200. That is, in the case of the method of requesting payment by a seller store terminal, the payment server 300 may receive a request of payment for the payer by receiving payment information of the payer from the seller interface unit 110 or the payer interface unit 120, and in the case of the method of requesting payment by a payer terminal, may receive a request of payment for the payer by receiving payment information of the payer from the payment terminal 200 (that is, by receiving payment information of the payer from the payment terminal 200 that has received a payment information identifier delivered from the payer interface unit 120).

The above-described embodiment will be described in detail with reference to FIG. 10. The payment server 300 receives a first payer identifier, which is identification information of a payer, and a first seller store identifier, which is identification information of a seller store, from the seller interface unit 110. Referring to FIG. 10, the payment server 300 may receive payment information of the payer from the seller interface unit 110 while receiving the first payer identifier and the first seller store identifier (i.e., the method of requesting payment by a seller store terminal).

In addition, the payment server 300 receives a second payer identifier and a second seller store identifier that match the first payer identifier and the first seller store identifier, respectively, from the payment terminal 200 in a normal payment situation. Here, the payment terminal 200 may acquire the first seller store identifier by tagging the first seller store identifier output through the second output unit 122 of the payer interface unit 120, and transmit the acquired first seller store identifier to the payment server 300 as a second seller store identifier.

The configuration of the payment server 300 receiving the first payer identifier, the first seller store identifier, and the payment information of the payer from the seller interface unit 110, and the configuration of the payment server 300 receiving the second payer identifier and the second seller store identifier from the payment terminal 200 are not limited to the time series order illustrated in FIG. 10.

Thereafter, the payment server 300 compares the first payer identifier and the first seller store identifier with the second payer identifier and the second seller store identifier, respectively, and when the first payer identifier and the first seller store identifier match the second payer identifier and the second seller store identifier, respectively, proceeds with payment for the payer based on the payment information of the payer and transmits the payment result to the seller store interface unit and the payment terminal 200.

With such a method, not only when the seller store identifier is an identifier of a dynamic change method, such as a QR code provided by the payer interface unit 120, but also when the seller store identifier is a fixed identifier, such as a QR code attached to a seller store in a printed form, may payment security be ensured. Further, the payer identifier may utilize payment information related to one or more selected from a member ID, a phone number, a nickname, and personal information of a payment service used by the payer according to the degree of security to be ensured. Alternatively, the payer identifier may utilize the entirety or a part of one among the pieces of payer information. For example, as a method of simplifying entering of the payer identifier, four digits of a phone number (e.g., the last four digits) may be used as a payer identifier, and as a method of enhancing the security, the entire phone number may be used as a payer identifier.

On the other hand, the present embodiment may be implemented as an embodiment in which the payer interface unit 120 receives a payer identifier from the payment terminal 200 as illustrated in FIG. 11, and accordingly, the payment server 300 may compare a first payer identifier and a first seller store identifier transmitted from the seller interface unit 110 with a second payer identifier and a second seller store identifier transmitted from the payer interface unit 120, respectively, and only when the first payer identifier and the first seller store identifier match the second payer identifier and the second seller store identifier, respectively, is payment proceeded with for the payer (here, the second payer identifier and the second seller store identifier are defined as a payer identifier and a seller store identifier transmitted from the payer interface unit 120). Through the above embodiment, when a payer identifier, such as a QR code, is a fixed identifier, the payer identifier may be prevented from being duplicated and changed by malicious intent.

Hereinafter, a method of acquiring the first payer identifier by the seller interface unit 110 in the embodiments of FIGS. 10 and 11 will be described. As a non-online method, the seller interface unit 110 may acquire the first payer identifier in a way in which a cashier of a seller store obtains the first payer identifier by orally receiving the first payer identifier from a payer or checking a medium marked with the first payer identifier (e.g., a service membership card), which is displayed to the cashier, and then inputting the received first payer identifier into the seller interface unit 110. As an online method, the seller interface unit 110 may acquire the first payer identifier in a way in which a separate integrated circuit (IC) chip storing the first payer identifier is tagged to the first input unit 111 of the seller interface unit 110. On the other hand, a member information inquiry process of the payment server 300 may search for and inquire about the payer identifier0 when more information is required for confirming the match of the payer identifier.

Meanwhile, in the embodiment shown in FIG. 10, the payment server 300 may receive a modulated identifier generated by modulating the first seller store identifier by the payer interface unit 120 and delivered through the payment terminal 200 and compare the second payer identifier and the second seller store identifier, which is extracted by demodulating the received modulated identifier, with the first payer identifier and the first seller store identifier, respectively.

Further, the modulated identifier may reflect a time-based key corresponding to a point in time at which the modulated identifier is modulated by the payer interface unit 120, and accordingly, the payment server 300 may be configured to proceed with payment for the payer only when a value of the time-based key extracted by demodulating the modulated identifier is different from a value corresponding to a point in time at which the modulated identifier is demodulated within a preset allowable range while the second payer identifier and the second seller store identifier, which is extracted by demodulating the modulated identifier, match the first payer identifier and the first seller store identifier, respectively, as a result of the comparison.

In this case, the modulated identifier may be generated as a modulated sound wave in an inaudible band.

The above-described embodiment will be described in detail with reference to FIGS. 12 to 14 in relation to an example in which the modulated identifier is generated as a modulated sound wave in an inaudible band.

Referring to FIG. 12, the payment server 300 may receive a modulated identifier generated by modulating the first seller store identifier by the payer interface unit 120 and delivered through the payment terminal 200. Here, the payer interface unit 120 may generate a modulated sound wave in an inaudible band by modulating the first seller store identifier as a modulated identifier and then deliver the modulated sound wave in an inaudible band to the payment terminal 200 through the second output unit 122 (e.g., a sound wave output device). Accordingly, the payment terminal 200 may transmit the received modulated sound wave in an inaudible band to the payment server 300 together with a second payer identifier.

In addition, the payment server 300 receives a first payer identifier, a first seller store identifier, and payment information of the payer from the seller interface unit 110.

Thereafter, the payment server 300 compares the second payer identifier and the second seller store identifier, which is extracted by demodulating the delivered modulated identifier, (that is, an identifier extracted by demodulating the modulated identifier that is generated by modulating the first seller store identifier, and referred to as a second seller store identifier to clearly indicate a seller store identifier that matches a first seller identifier in a normal payment situation and is delivered from the payment terminal 200) with the first payment identifier and the first seller store identifier, respectively, and when the second payment identifier and the second seller store identifier match the first payment identifier and the first seller store identifier, respectively, proceed with payment for the payer and transmit a result of the payment to the seller store interface unit and the payment terminal 200.

In this case, as described above, the modulated identifier may reflect a time-based key corresponding to a point in time at which the modulated identifier is modulated by the payer interface unit 120.

Referring to FIG. 13, a specific example will be described. When modulating the first seller store identifier, the payer interface unit 120 may generate a modulated identifier by reflecting a time-based key corresponding to a point in time of the modulation as a modulated sound wave in an inaudible band. Therefore, the modulated sound wave in an inaudible band, in which the time-based key corresponding to the point in time of the modulation is reflected, has a one-time use characteristic, and thus has a characteristic of invalidating a payment when the payment is attempted by malicious copying.

Accordingly, the payment server 300 may proceed with payment for the payer only when a value of the time-based key extracted by demodulating the modulated identifier is different from a value corresponding to a point in time at which the modulated identifier is demodulated within a preset allowable range while the second payer identifier and the second seller store identifier, which is extracted by demodulating the modulated identifier, match the first payer identifier and the first seller store identifier, respectively, as a result of the comparison.

That is, only when it is determined that, while the first payer identifier and the first seller store identifier match the second payer identifier and the second seller store identifier, respectively, a value of the time-based key extracted by demodulating the modulated identifier matches a value corresponding to a point in time at which the modulated identifier is modulated, the payment server 300 may operate to proceed with payment for the payer. However, since a predetermined time difference may exist between the time of the modulation of the payer interface unit 120 and the time of the demodulation of the payment server 300, the payment server 300 may proceed with payment for the payer only when the difference between the value of the time-based key extracted by demodulating the modulated identifier and the value corresponding to the point in time at which the modulated identifier is demodulated is within a preset allowable range. The allowable range may be appropriately designed in consideration of a typical communication delay time and may be preset in the payment server 300.

Accordingly, when the difference between the value of the time-based key extracted by demodulating the modulated identifier and the value corresponding to the point in time at which the modulated identifier is demodulated is out of the allowable range, the payment server 300 considers the payment request invalid and does not proceed with payment.

In addition, referring to FIG. 14, according to an electronic online method, the seller interface unit 110 may acquire the first payment identifier by a method of allowing a separate IC chip storing the first payer identifier to be tagged onto the first input unit 111 of the seller interface unit 110 so that payment security may be ensured regardless of the integrity of the first seller store identifier of the payer interface unit 120. In addition, by determining whether the first seller store identifier matches the second seller store identifier, payment security may be further improved.

On the other hand, the above description has been made in relation to an embodiment in which the payer interface unit 120 generates a modulated identifier, but according to an embodiment, as shown in FIG. 15, the payment interface device 100 may deliver dynamic information including a seller store identifier (a first seller store identifier) and a time-based key to the payment server 300k, and the payment server 300 may modulate the received dynamic information to generate a modulated identifier (e.g., an modulated sound wave in an inaudible band), and transmit the generated modulated identifier to the payment interface device 100. In this case, the payment server 300 may include an authentication server that generates a modulated identifier as a lower server.

In addition, unlike the example shown in FIG. 15 in which dynamic information of a seller store is used, an embodiment in which dynamic information of the payment server 300 is used may be implemented. That is, as shown in FIG. 16, the payment server 300 may generate a modulated identifier (e.g., an modulated sound wave in an inaudible band) reflecting dynamic information (i.e., time information) of the payment server 300 and transmit the modulated identifier to the payment interface device 100, and the payment terminal 200 may receive the modulated identifier output from the payment interface device 100 and transmit the received modulated identifier to the payment server 300 together with payment information of the payer. Thereafter, the payment server 300 may demodulate the modulated identifier delivered from the payment terminal 200, determine whether the time difference between the time of the modulation and the time of the demodulation is within an allowable range to determine validity, and proceed with payment for the payer only when the time difference is within the allowable range.

FIG. 17 is an exemplary diagram for describing a payment method according to the fourth embodiment of the present invention.

Referring to FIG. 17, the payment method according to the fourth embodiment of the present invention will be described. First, the payment server 300 receive a first payer identifier, which is identification information of the payer, and a first seller store identifier, which is identification information of a seller store, from the seller interface unit 110 (S1710).

Subsequently, the payment server 300 receives a second payer identifier and a second seller store identifier that match the first payer identifier and the first seller store identifier, respectively, from the payment terminal 200 in a normal payment situation (S1720).

Subsequently, the payment server 300 compares the first payer identifier and the first seller store identifier with the second payer identifier and the second seller store identifier, respectively, and proceeds with payment for the payer based on payment information of the payer only when the first payer identifier and the first seller store identifier match the second payer identifier and the second seller store identifier, respectively (S1730).

In operation S1720, the payment server 300 may receive a modulated identifier generated by modulating the first seller store identifier by the payer interface unit 120 and delivered through the payment terminal 200, and accordingly, in operation S1730, the payment server 300 may compare the second payer identifier and the second seller store identifier, which is extracted by demodulating the transmitted modulated identifier, with the first payer identifier and the first seller store identifier, respectively.

Further, the modulated identifier may reflect a time-based key corresponding to a point in time at which the modulated identifier is modulated by the payer interface unit 120, and accordingly, the payment server 300 may proceed with payment for the payer only when a value of the time-based key extracted by demodulating the modulated identifier is different from a value corresponding to the point in time at which the modulated identifier is demodulated within a preset allowable range while the second payer identifier and the second seller store identifier, which is extracted by demodulating the modulated identifier, match the first payer identifier and the first seller store identifier, respectively, as a result of the comparison.

The above-described embodiment has been given in relation to an example in which the payer interface unit 120 generates a modulated identifier in a method of requesting payment by a seller store terminal from the perspective of the payment server 300. However, according to an embodiment, an example in which the seller interface unit 110 generates a modulated identifier in a method of requesting payment by a payer terminal may be implemented. FIGS. 18 to 20 are exemplary diagrams for describing an operation of the payment interface device 100 according to the fourth embodiment of the present invention. Detailed description will be made with reference to FIGS. 18 to 20.

The seller interface unit 110 may generate a modulated identifier by modulating a payer identifier, which is identification information of a payer who has purchased a product, payment information of the payer, and a seller store identifier, which is identification information of a seller store.

The payer interface unit 120 may transmit the modulated identifier delivered from the seller interface unit 110 such that the payment terminal 200 possessed by the payer recognizes the modulated identifier and requests payment for the payer to the payment server 300 and thus the payment server 300 demodulates the modulated identifier and proceeds with the payment for the payer.

Referring to FIG. 18, a specific example will be described. The seller interface unit 110 may generate a modulated identifier by modulating a payer identifier, payment information, and a seller store identifier, and transmit the generated modulated identifier to the payer interface unit 120, and the payer interface unit 120 may output the delivered modulated identifier. Accordingly, the payment terminal 200 may acquire the modulated identifier output form the payer interface unit 120 and transmit the modulated identifier to the payment server 300, and the payment server 300 may demodulate the received modulated identifier and proceed with payment for the payer.

The embodiment of FIG. 18 may also be applied to when payments are performed for a plurality of payers. Specifically, the payer includes a first payer and a second payer (i.e., a plurality of payers), and the payment terminal 200 may include a first payment terminal 210 and a second payment terminal 220 possessed by the first payer and the second payer, respectively.

Accordingly, the seller interface unit 110 may generate a first modulated identifier by modulating a first payer identifier, which is identification information of the first payer, payment information of the first payer, and a seller store identifier, and may generate a second modulated identifier by modulating a second payer identifier, which is identification information of the second payer, payment information of the second payer, and the seller store identifier.

The payer interface unit 120 may transmit the first and second modulated identifiers delivered from the seller interface unit 110 such that the first and second payment terminals 210 and 220 recognize the first and second modulated identifiers, respectively, and request payments for the first and second payers to the payment server 300, and thus the payment server 300 demodulates the first and second modulated identifiers and proceeds with the payments for the first and second payer.

Referring to FIG. 19, a specific example will be described. The seller interface unit 110 may generate a first modulated identifier by modulating a first payer identifier, payment information of a first payer (first payment information), and a seller store identifier and transmit the generated first modulated identifier to the payer interface unit 120, and the payer interface unit 120 may output the received first modulated identifier. Accordingly, the first payment terminal 210 may acquire the first modulated identifier output from the payer interface unit 120 and transmit the acquired first modulated identifier to the payment server 300, and the payment server 300 may demodulate the received first modulated identifier and proceed with payment for the first payer. In this case, when the first payer identifier is provided in the form of an inaudible band sound wave, the first payment terminal 210 may acquire the first modulated identifier, extract a sound wave pattern corresponding to the first payer identifier, and only when the sound wave pattern matches a payer identifier in the form of an inaudible band sound wave possessed by the first payment terminal 210, transmit the first modulated identifier to the payment server 300.

Similarly, the seller interface unit 110 may generate a second modulated identifier by modulating a second payer identifier, payment information of a second payer (second payment information), and the seller store identifier and transmit the generated second modulated identifier to the payer interface unit 120, and the payer interface unit 120 may output the received second modulated identifier. Accordingly, the second payment terminal 220 may acquire the second modulated identifier output from the payer interface unit 120 and transmit the acquired second modulated identifier to the payment server 300, and the payment server 300 may demodulate the received second modulated identifier and proceed with payment for the second payer. In this case, when the second payer identifier is provided in the form of an inaudible band sound wave, the second payment terminal 220 acquires the second modulated identifier, extracts a sound wave pattern corresponding to the second payer identifier, and only when the sound wave pattern matches a payer identifier in the form of an inaudible band sound wave possessed by the second payment terminal 220, transmits the second modulated identifier to the payment server 300.

On the other hand, the embodiment of FIG. 18 may be applied to performing payment according to a plurality of payment services. Specifically, the payer interface unit 120 may include a first payer interface unit 120A and a second payer interface unit 120B for performing payment according to a first payment service and payment a second payment service, respectively.

Accordingly, the seller interface unit 110 may modulate a first modulated identifier and a second modulated identifier by modulating a payer identifier, payment information, and a seller store identifier on the basis of a protocol according to the first payment service and a protocol according to the second payment service, respectively.

The payer interface unit 120 may transmit the first and second modulate identifiers delivered form the seller interface unit 110 such that one of the modulated identifiers according to a payment service selected through the payment terminal 200 is recognized and payment for the payer is requested to the payment server 300 according to the selected payment service.

Referring to FIG. 20, a specific example will be described. The seller interface unit 110 may generate a first modulated identifier by modulating a payer identifier, payment information, and a seller store identifier based on a protocol according to the first payment service and transmit the generated first modulated identifier to the first payer interface unit 120A, and the payment terminal 200 may acquire the first modulated identifier output from the first payer interface unit 120A.

Similarly, the seller interface unit 110 may generate a second modulated identifier by modulating the payer identifier, the payment information, and the seller store identifier based on a protocol according to the second payment service and transmit the generated second modulated identifier to the second payer interface unit 120B, and the payment terminal 200 may acquire the second modulated identifier output from the second payer interface unit 120B.

In this case, when the payer selects the second payment service through the payment terminal 200, the payment terminal 200 may transmit the second modulated identifier between the acquired modulated identifiers to the second payment server 320 according to the second payment service. Accordingly, the second payment server 320 may demodulate the second modulated identifier and proceed with payment for the payer.

Although the above embodiment has been described in relation to a configuration in which the payment server 300 demodulates the modulated identifier, another embodiment may be implemented with a configuration in which the payment terminal 200 demodulates the modulated identifier and requests payment to the payment server.

The configuration will be described based on an operation of the first payment terminal 210. Referring to FIG. 21, the first payment terminal 210 may acquire the first modulated identifier, demodulate the acquired first modulated identifier to acquire the first payer identifier, and only when the acquired first payer identifier matches a payer identifier possessed by the first payment terminal 210, transmit the first payment information to the payment server 300 and request payment for the first payer.

FIG. 22 is an exemplary diagram for describing a payment method according to the fourth embodiment of the present invention.

Referring to FIG. 22, another payment method according to the fourth embodiment of the present invention will be described. The seller interface unit 110 generates a modulated identifier by modulating a payer identifier, which is identification information of a payer who has purchased a product, payment information of the payer, and a seller store identifier, which is identification information of a seller store (S2110).

Subsequently, the payer interface unit 120 transmits the modulated identifier delivered from the seller interface unit 110 such that the payment terminal 200 possessed by the payer recognizes the modulated identifier and requests payment for the payer to the payment server 300 and thus the payment server 300 demodulates the modulated identifier and proceeds with the payment for the payer (S2120).

As described above, the embodiment may improve the convenience of payment by dividing a seller store terminal provided at a seller store into an interface device for a casher of a seller store and an interface device for a payer and may improve payment security by employing a system of checking whether an identification code of a seller store delivered from a payer corresponds to an actual identification code output from a seller store terminal.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

What is claimed is:

1. A payment interface device comprising:
a seller interface unit configured to acquire a payer identifier, which is identification information of a payer who has purchased a product, from a payment terminal possessed by the payer, receive payment information of the payer to be matched with the acquired payer identifier, and request payment for the payer to a payment server on the basis of the input payment information; and
a payer interface unit configured to be dividable from the seller interface unit and provide the payer with the payment information input into the seller interface unit.

2. The payment interface device of claim 1, wherein the seller interface unit receives the payment information through a method of outputting the payer identifier acquired from the payment terminal and receiving the payment information to be matched with the output payer identifier or through a method of converting the payer identifier acquired from the payment terminal into a payer identifier of a predetermined type, outputting the converted payer identifier, and receiving the payment information to be matched with the converted output payer identifier.

3. The payment interface device of claim 1, wherein the seller interface unit generates one or more service-linked payer identifiers for linking with one or more payment services on the basis of the acquired payer identifier and receives the payment information of the payer to be matched with a service-linked payer identifier selected by a seller among the generated one or more service-linked payer identifiers.

4. The payment interface device of claim 1, wherein the seller interface unit receives the payer identifier delivered from the payer interface unit that has acquired the payer identifier output on the payment terminal or directly receives the payer identifier from the payment terminal so that the seller interface unit acquires the payer identifier.

5. A payment server for performing payment for a payer who has purchased a product by communicating with a payment interface device including a seller interface unit and a payer interface unit and a payment terminal possessed by the payer, the payment server configured to:
receive a first payer identifier, which is identification information of the payer, and a first seller store identifier, which is identification information of a seller store, from the seller interface unit;
receive a second payer identifier and a second seller store identifier that match the first payer identifier and the first seller store identifier, respectively, from the payment terminal in a normal payment situation; and
compare the first payer identifier and the first seller store identifier with the second payer identifier and the second seller store identifier, respectively, and only when it is determined that the first payer identifier and the first seller store identifier match the second payer identifier and the second seller store identifier, respectively, perform the payment for the payer on the basis of payment information of the payer.

6. The payment server of claim 5, wherein the payment server receives a modulated identifier that is generated by modulating the first seller store identifier by the payer interface unit and delivered through the payment terminal and compares the second payer identifier and the second seller store identifier, which is extracted by demodulating the received modulated identifier, with the first payer identifier and the first seller store identifier, respectively.

7. The payment server of claim 6, wherein the modulated identifier reflects a time-based key corresponding to a point in time at which the modulated identifier is modulated by the payer interface unit, and
the payment server proceeds with payment for the payer only when a value of the time-based key extracted by demodulating the modulated identifier is different from a value corresponding to a point in time at which the modulated identifier is demodulated within a preset allowable range while the second payer identifier and the second seller store identifier, which is extracted by demodulating the modulated identifier, match the first payer identifier and the first seller store identifier, respectively, as a result of the comparison.

8. The payment server of claim 7, wherein the modulated identifier is generated as a modulated sound wave in an inaudible band.

9. The payment server of claim 5, wherein the payment server receives the payment information of the payer that is delivered from one of the seller interface unit, the payer interface unit, and the payment terminal, thereby receiving a request of the payment for the payer.

10. A payment interface device comprising:
a seller interface unit configured to modulate a payer identifier, which is identification information of a payer who has purchased a product, payment information of the payer, and a seller store identifier, which is identification information of a seller store, to generate a modulated identifier; and
a payer interface unit configured to transmit the modulated identifier delivered from the seller interface unit such that a payment terminal possessed by the payer recognizes the modulated identifier and requests payment for the payer to a payment server, and thus the payment server demodulates the modulated identifier and performs the payment for the payer.

11. The payment interface device of claim 10, wherein the payer includes a first payer and a second payer, and the payment terminal includes a first payment terminal and a second payment terminal possessed by the first payer and the second payer, respectively,
the seller interface unit modulates a first payer identifier, which is identification information of the first payer, payment information of the first payer, and the seller store identifier to generate a first modulated identifier and modulates a second payer identifier, which is identification information of the second payer, payment information of the second payer, and the seller store identifier to generate a second modulated identifier, and
the payer interface unit transmits the first and second modulated identifiers delivered from the seller interface unit such that the first and second payment terminals recognize the first and second modulated identifiers, respectively, and request payments for the first and second payers to the payment server and thus the payment server demodulates the first and second modulated identifiers and performs the payments for the first and second payers.

12. The payment interface device of claim 11, wherein the payer interface unit includes a first payer interface unit and a second payer interface unit for performing payment according to a first payment service and payment according to a second payment service, respectively;
the seller interface unit modulates the payer identifier, the payment information, and the seller store identifier based on a protocol according to the first payment service to generate a first modulated identifier and modulates the payer identifier, the payment information, and the seller store identifier based on a protocol according to the second payment service to generate a second modulated identifier, and
the payer interface unit transmits the first and second modulated identifiers delivered from the seller interface unit such that a modulated identifier according to the payment service selected through the payment terminal between the first and second modulated identifiers is recognized, and payment for the payer is requested to the payment server according to the selected payment service.
